(19) United States
(12) Patent Application Publication
(10) Pub. No.: US 2004/0249687 A1
(43) Pub. Date: Dec. 9, 2004

(54) System and method for evaluating investment fund manager performance

(76) Inventors: James H. Lowell, Needham, MA (US); Burton D. Sheppard, Mattapoisett, MA (US)

Correspondence Address: KIRKPATRICK & LOCKHART LLP, 75 STATE STREET, BOSTON, MA, 02109-1808, US

(21) Appl. No.: 10/457,286

(22) Filed: Jun. 9, 2003

(51) Int. Cl. G06F 17/60

(52) U.S. Cl. 705/7

(57) ABSTRACT

This invention relates to a system and method of evaluating investment fund manager performance including collecting career information for a plurality of investment fund managers, collecting fund information for a plurality of investment funds across a fund universe, associating the career information of an investment fund manager to the fund information for related investment funds to generate career performance information for each of the plurality of investment fund managers, determining a group of investment fund managers based on at least one criterion, comparing the career performance information of at least one member of the group to a benchmark to generate at least one career performance record, and analyzing the at least one career performance record.

### FIELD OF THE INVENTION

This invention relates to evaluating an investment fund manager's performance and, more particularly, to evaluating the performance based on the career performance of the manager.

### BACKGROUND OF THE INVENTION

An investment fund is typically evaluated based on the fund's past performance and conventional financial information available for the fund and/or the underlying securities, such as return, yield or price-to-earnings ratio. Existing evaluative methods and tools monitor and rate the current and historical fund performance.

### SUMMARY OF THE INVENTION

In general, in one aspect, the invention features a method for evaluating investment fund manager performance. The method includes collecting career information for a plurality of investment fund managers, collecting fund information for a plurality of investment funds across a fund universe, associating the career information of an investment fund manager to the fund information for related investment funds to generate career performance information for each of the plurality of investment fund managers, determining a group of investment fund managers based on at least one criterion, comparing the career performance information of at least one member of the group to a benchmark to generate at least one career performance record, and analyzing the at least one career performance record.

In general, in another aspect, the invention features a system for evaluating investment fund manager performance, including a user interface for receiving career information for a plurality of investment fund managers and receiving fund information for a plurality of investment funds, a memory for storing the career information and the fund information, and a processor coupled to the user interface and the memory, the processor performing the steps of associating the career information of an investment fund manager to the fund information for related investment funds to generate career performance information for each of the plurality of investment fund managers, determining a group of investment fund managers based on at least one criterion, comparing the career performance information of at least one member of the group to a benchmark to generate at least one career performance record, and analyzing the at least one career performance record.

An advantage of the present invention is that the performance of an investment fund manager is objectively evaluated against a closely correlated benchmark which reduces or eliminates market fluctuations. An additional advantage of the present invention is that the career performance of an investment fund manager is evaluated, which provides a long-term assessment of a fund manager's performance record.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a flow diagram showing a method of evaluating manager performance according to an embodiment of the present invention; and

FIG. 2 is a schematic drawing of the components of an investment fund manager performance evaluation system according to an embodiment of the present invention.

### DETAILED DESCRIPTION OF THE INVENTION

An important determinant of fund performance in actively managed funds is the fund management. For example, when considering a fund that has had the same manager for years, the fund's performance, and thus the manager's performance, is relatively simple to gauge against competing funds with similar holdings and risk. However, a fund manager's performance is more difficult to measure when a manager has managed a number or variety of funds, or has managed funds within a particular style or with an investment objective that may dictate how or where a fund manager may invest. Therefore, it is important to know how much and how consistently an investment fund manager has beaten the most relevant market indices and with how much risk. As used herein, a fund manager is any manager of record of the identified investment funds, such as an individual manager or team of managers, identified by name rather than by their fund complex or fund name.

The present invention relates to a system and method for evaluating investment fund manager performance in which a manager's career performance is objectively evaluated based on one or more criteria. In one embodiment, the career performance of an individual manager or managers is tracked and ranked according to objective criteria, such as relevant benchmarks and peer groups, creating a career performance record or records. The career performance records are analyzed and a list or lists are constructed based upon the best performing managers in various generic and customized categories and/or styles. The list or lists are used to create an index or indices which track the performance of a segment of the market, e.g., the top performing, such as the upper quintile, of managers in each category or other group across an entire universe of fund managers. The index or indices are based on the performance of fund managers rather than baskets of equities, which constitute a comprehensive suite of generic and/or customized investment manager performance-based benchmarks of the best performing managers.

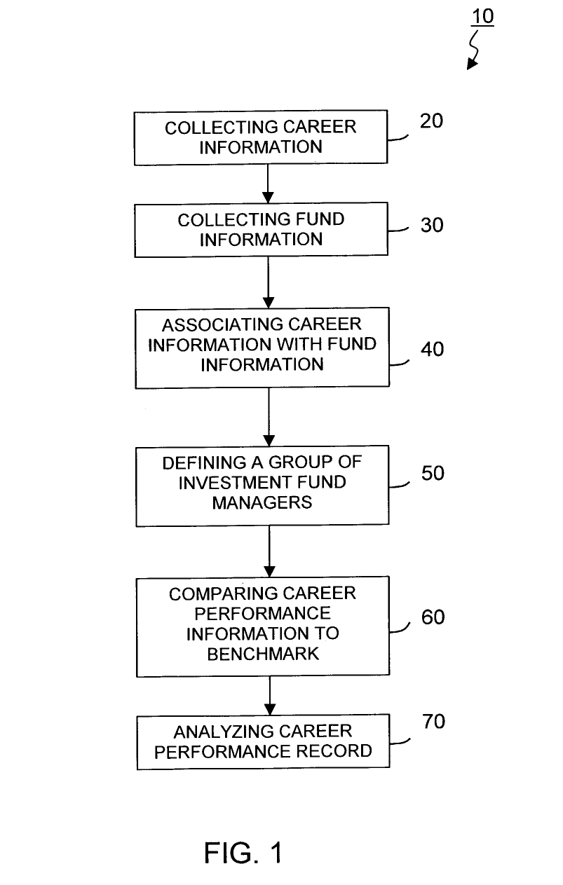

FIG. 1 shows a method 10 of evaluating investment fund manager performance according to an embodiment of the present invention. The method 10 includes collecting career information for each investment fund manager to be evaluated (step 20). The career information may include a variety of information, such as an inception date, end date and name of any investment fund a manager has managed over his or her career, preferably over the past year and more preferably over the past five to ten years. The career information may also include a manager's biographical data, such as job related information, education related information or any other individual characteristic.

In step 30, fund information is collected for a variety of investment funds across a fund universe. Fund information may be performance data of the fund, such as net asset value, yield, total return. Fund information may be data about the fund, such as a fund name; an investment objective, e.g., equity—income, growth, equity—income and growth, capital appreciation, small company growth, sector, global, international, specialty; a risk factor, e.g., volatility, predictability; a fund type, e.g., stock/equity, bond, money market, balanced. Other fund information that is available as well known to those skilled in the art may also be collected. A fund universe may be retail closed-end mutual funds, retail open-end mutual funds, international funds, separate accounts, hedge funds, private equity, venture capital or alternative asset classes, e.g., real estate, oil and gas, commodities. Other funds that are well known to those skilled in the art may also be used.

The career information of an investment fund manager is then associated with the fund information for all investment funds the manager has managed (step 40). For instance, for each fund manager, the fund information related to one or more funds the manager has managed for a given period of time is associated or attributed to that manager. For example, if three investment fund managers have each managed three funds over the past five years (see Table 1 below), manager X is attributed with the fund information for Fund A for 1998, Fund B for 1999-2000 and Fund C for 2001-2002, manager Y is attributed with the fund information for Fund A for 1999-2000, Fund B for 2001-2002 and Fund C for 1998 and manager Z is attributed with the fund information for Fund A for 2001-2002, Fund B for 1998 and Fund C for 1999-2000. Thus, career performance information for each fund manager is generated or created from the fund information of one or more funds the manager has managed.

TABLE 1

| | Fund A | Fund B | Fund C |
|---|---|---|---|
| Manager X | January 1998- | January 1999- | January 2001- |
| | December 1998 | December 2000 | December 2002 |
| Manager Y | January 1999- | January 2001- | January 1998- |
| | December 2000 | December 2002 | December 1998 |
| Manager Z | January 2001- | January 1998- | January 1999- |
| | December 2002 | December 1998 | December 2000 |

In step 50, a group of investment fund managers is defined based on one or more criteria. The criteria may include a specified time period, e.g., previous year, three year, five year period; a market condition, e.g., bull market, bear market; a risk related condition; an investment objective, e.g., equity—income, growth, equity—income and growth, capital appreciation, small company growth, sector, global, international, specialty; a risk factor, e.g., volatility, predictability; a fund type, e.g., stock/equity, bond, money market, balanced.

For instance, if interested in large-cap, multi-cap, mid-cap or small-cap funds, based on growth, blend or value styles, all managers who have managed a fund or funds that fall within a particular group may be defined or selected. For example, all managers who have managed large-cap growth funds over the past three years may be selected.

In step 60, the career performance information of at least one member of the defined group of investment fund managers is compared to a benchmark or benchmarks to generate at least one career performance record. A benchmark may be any closely correlated benchmark, such as any standard or proprietary index or indices, the defined group of investment fund managers, another member of the defined group of investment fund managers, or a fund family. For instance, a proprietary index or indices may be based on the performance evaluation of a defined group of managers and/or a member of the defined group of managers. A benchmark may be another comparative group or standard, such as a second defined group of investment fund managers or another member of the second defined group of investment fund managers. Other suitable benchmarks may be used as well known to those skilled in the art.

For instance, for each of the variety of investment funds across a fund universe, a closely correlated unmanaged index benchmark from one or more style, industry or international indices may be chosen for comparison. An index benchmark is any index or set of indices chosen to approximately match a fund's “neutral” style or other position. For example, a fund intended to be a large-cap growth vehicle would generally be compared to a large-cap growth index, such as the S&P/Barra 500 Growth index. An index benchmark generally remains fixed to a fund's stated style or objective so that a manager's performance may be compared to a relatively fixed benchmark. A fund's index benchmark may change over time if the fund's stated investment goals are changed, as generally reflected in the fund's prospectus. Using the previous example, if Fund C changes its stated investment objective in January 2001 and goes from a large-cap growth fund to a large-cap value fund, then the index benchmark that Fund C, and thus Manager X, is compared against may change to a different benchmark, e.g., from the S&P/Barra 500 Growth index to S&P/Barra Large Cap Value index.

Examples of three major large-cap growth index benchmarks are the S&P/Barra 500 Growth, the Russell 1000 Growth, and the Wilshire 750 Growth (each is alternately named with “large-cap” replacing the numbers shown here, e.g., the Wilshire Large-Cap Growth index). The numerals represent the number of stocks held in each broad index, e.g., the Russell 1000 index is composed of the 1000 largest U.S. firms by market-capitalization, and the more growth-oriented half of those firms are in the Russell 1000 Growth index. An example of an all-cap/multi-cap growth index benchmark is the Wilshire 5000 Growth, a highly concentrated growth index benchmark is the Wilshire Target Large-Growth, and a sector index benchmark is the Dow Jones Technology sector index (TEC). As a further example, Nasdaq funds may be compared to the Nasdaq Composite benchmark. Other suitable index benchmarks are well known to those skilled in the art.

When using an index benchmark, it is important to be aware of how different benchmarks are determined so that a manager's performance may be properly evaluated for each of the investment funds. For instance, some indices have different criteria for splitting each index into the growth and value areas. For example, S&P/Barra divides the stocks solely based on their price-to-book value ratios, while Wilshire and Russell combine price-to-book with an earnings measure. Wilshire uses a price-to-earnings ratio based on projected analyst earnings for the next year as provided by Institutional/Broker/Estimate/Service (I/B/E/S). Instead of price-to-earnings ratio, Russell uses the mean forecast for long-term growth, also provided by I/B/E/S.

An advantage of S&P/Barra's sole focus on book values is that it is more fixed, requiring less turnover in what is supposed to be an “unmanaged” benchmark. An advantage of including earnings measures is that most managers seeking “growth” look at earnings growth and price-to-earnings ratios as important components of defining their investment universe.

After generating a career performance record for each manager to be evaluated in the group, the one or more career performance records are analyzed (step 70). The analyzing step may analyze index volatility, manager volatility, front-weighted average return, seasonality, cyclicality, relative and/or absolute returns, e.g., relative return career, five year relative return, three year relative return, two year relative return, one year relative return, risk-adjusted relative return career, risk-adjusted index return. Other suitable categories may be used to evaluate performance as well known to those skilled in the art. All performance numbers may be annualized, i.e., calculated as return per year, and all returns may be calculated or evaluated on a daily, weekly, monthly, quarterly, and/or yearly basis.

For instance, relative return is a fund or manager's return after subtracting out the return of a relevant benchmark index. For example, if a large-cap growth fund is up 21% for a given period, but the S&P 500 Growth index gained 10% for the same period, then the fund's relative return is a positive 10%. Thus, a manager has beaten the market by a relative return of 10%. A one year, two year, three year or five year relative return looks at a fund or manager's relative return for the stated period of time. A manager's relative return career analyzes the relative return of a fund or funds a manager has managed over his or her career. Front-weighted average relative return is the average of a manager's career, five-year, three-year, two-year and one-year relative performances. Absolute or total return is a fund or manager's return without factoring out the relevant benchmark.

The relative volatility is a measure of a fund's risk. Volatility is the standard deviation, or uncertainty, of a fund's return. For instance, a fund which goes up about the same each month, e.g., a money market, has very low risk, while a fund whose performance is more erratic has a higher relative volatility and is said to be more “risky.” For a manager's funds or benchmark indexes, relative volatility is the standard deviation of monthly returns for a period, divided by the same standard deviation figure for the S&P 500 index.

Risk-adjusted return is a figure that permits comparisons between the total return of funds and/or investment models or indexes of varying levels of risk, by factoring out differences in volatility. For instance, a fund's risk-adjusted return is the return one would obtain with a portfolio holding the fund and enough cash reserves or similar zero-volatility investment or, for low-risk funds, enough margin to maintain the risk level of the S&P 500. For example, for a fund with a relative volatility of 1.25, a portfolio would be constructed of 80% of that fund, and 20% of a cash position, giving the hypothetical portfolio a volatility of 1.00. Thus, the returns for this hypothetical portfolio are the fund's risk-adjusted return. For funds compared to an index or indices other than the S&P 500, risk-adjusted index return may be calculated for that index.

Risk-adjusted relative return career is a manager's return over his or her career after factoring out both the fund's correlated benchmark, e.g., the S&P/Barra 500 large-cap growth index and the level of risk the manager has taken on relative to that index. For instance, a positive number means relatively successful active management, while a significantly negative number means relatively unsuccessful active management. However, industry-wide, a manager's risk-adjusted relative return career may on average earn somewhat negative numbers due to fund expenses, brokerage commissions and/or bid-ask spreads.

Seasonality looks at a manager's beta-weighted return relative to an appropriate benchmark. Beta is a measure of the extent to which a fund or stock's value tends to go up or down as the market or another index benchmark goes up or down. Beta is that portion of relative volatility which is due to movements in the overall stock market or market benchmark, so a fund's beta is, for a given benchmark, always the same as or lower than relative volatility. For each month, a manager's return is divided by his or her beta and then the benchmark's return is subtracted from the beta-adjusted manager return to get a neutral month-by-month relative return. The month-by-month relative return is averaged out for each calendar month, and the data is collected for each month over a manager's career. For instance, a manager with a sixty-month history will have five adjusted January returns averaged, five February returns averaged, five March returns averaged, etc.

Cyclicality is similar to seasonality except a cyclical period is analyzed. The period or cycle may be a month, several months, a year or more. Cyclicality looks at a manager's beta-weighted return relative to an appropriate benchmark. For each month, a manager's return is divided by his or her beta and then the benchmark's return is subtracted from the beta-adjusted manager return to get a neutral month-by-month relative return. The month-by-month relative return is averaged out for each cyclical period, and the data is collected for each cyclical period over a manager's career. For instance, a manager with a sixty-month history may have five adjusted cyclical returns averaged, five cycles consisting of one or more months' returns averaged.

The analyzing step (step 70) may entail tracking, monitoring, reviewing, and/or ranking one or more managers based on their career performance record. For instance, all managers to be evaluated may be given a ranking score which analyzes the average of their risk-adjusted relative return career and their unadjusted front-weighted average performance. Since these are trailing figures that are not fixed to a calendar year, a manager's score may be updated monthly, quarterly, or on any schedule. Based on a manager's ranking score, one or more lists may be generated that rank all investment fund managers to be evaluated and/or identify the top-ranked investment fund managers in any selected or specified group. The generated list or lists may then be used to create or construct an index or indices, which in turn may be used as a benchmark.

For instance, managers' performances in defined or selected categories, styles and/or sectors are analyzed and ranked. A percentage of these managers are then identified, and an index or indices are created from the list of identified managers. For example, large cap indices may be created by analyzing managers' performance in the large cap growth, large cap value and large cap blended areas. An index for each of these areas is then created based on the top, e.g., upper quintile, best performing managers.

An index or indices may be readjusted or rebalanced by evaluating the rankings of the managers on a periodic basis, such as quarterly, semi-annually, or annually or at a specified time, such as triple-witching day. Managers that fall outside of the percentage may be removed from the list whereas managers that now fall within the percentage may be added. The index or indices may then be used as a benchmark in evaluating other investment fund managers. For instance, an index may be used as a benchmark for evaluating fund managers in the same group being analyzed or a different group. For example, a large cap growth index listing managers in the top twentieth percentile may then be used as a benchmark to compare other managers in the large cap growth area or to compare other managers in the large cap value areas.

The index or indices created may then be used as a basis to create or construct one or more investment vehicles or financial instruments based on the generated lists of fund managers evaluated in any of the defined areas or groups. The investment vehicles, such as index-based funds, exchange traded funds, options, or segmented category/style related investment funds, treat the ranked and/or identified managers as if they are the securities.

The investment fund manager's performance evaluation may be used in a number of ways. For instance, a manager's performance evaluation may be used to determine his or her eligibility for incentive programs, such as bonuses, profit sharing plans, and stock options, or may be used in an annual review process. A manager's performance evaluation may be used to review a manager's performance relative to various peer groups, categories and/or standards, allowing substantial quantitative and qualitative monitoring of a manager's performance. A manager's performance evaluation may be used to monitor and/or measure fiduciary compliance of legislative, regulatory, and/or common law responsibilities, such as independent trustees of mutual funds. A manager's performance evaluation may be used in the due diligence, screening, manager identification and selection, and performance monitoring and measurement applications designed and intended to fulfill, in part or whole, certain fiduciary obligations of certain trustees and other officials of funds so as to enhance the monitoring function of fiduciaries, for example, under ERISA Section 404(c), and to constitute performance measurement under SEC interpretations of Section 28(e). A manager's performance evaluation may be used to track a manager's past investment actions and consequences for a fund or funds.

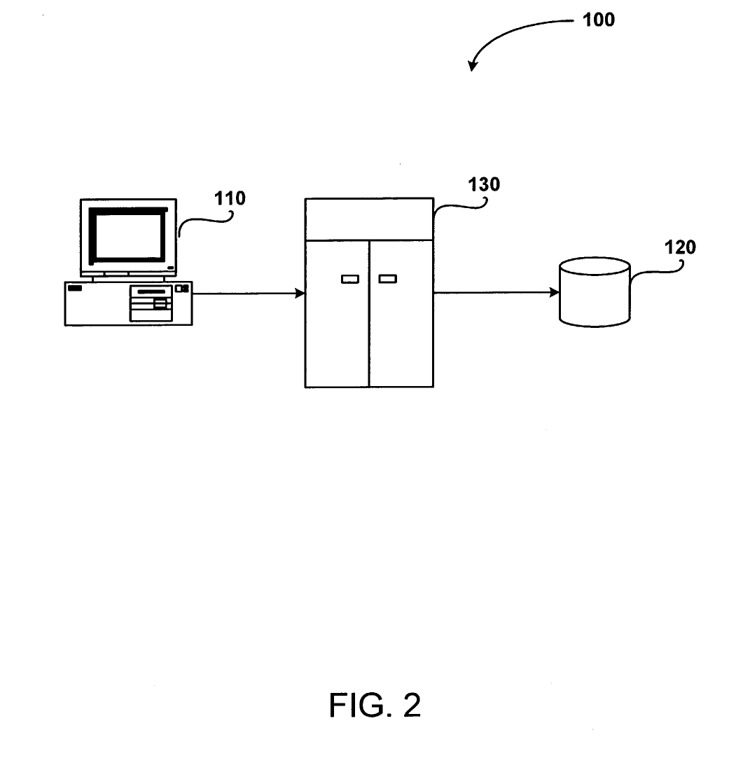

FIG. 2 shows an investment fund manager performance evaluation system 100 according to an embodiment of the present invention. The performance evaluation system 100 includes a user interface 110, a memory 120 and a processor 130 coupled to user interface 110 and memory 120. User interface 110 may be a display device, keyboard, mouse, modem, network or Internet connection and/or any interface as well known to those skilled in the art which allows career information to be received for a plurality of investment fund managers and fund information to be received for a plurality of investment funds. Memory 120, such as a computer-readable medium, may entail one or more databases for storing a plurality of entries containing one or more managers' career information and fund information. Processor 130 performs the steps of associating the career information of an investment fund manager to the fund information for one or more related investment funds to generate career performance information for each of the plurality of investment fund managers, determining a group of investment fund managers based on one or more criteria, comparing the career performance information of at least one member of the group to a benchmark to generate at least one career performance record, and analyzing the at least one career performance record. The one or more criteria may be selected by a user or determined by another means.

The processor 130 may additionally perform the step of generating one or more lists that rank all investment fund managers to be evaluated and/or identifies a percentage of the ranked investment fund managers in any selected or specified group. The processor 130 may also perform the steps of creating one or more indices and creating one or more investment vehicles.

Various modifications and alterations of this invention will be apparent to those skilled in the art without departing from the scope and spirit of this invention. This invention should not be restricted to that set forth herein for illustrative purposes only.

What is claimed is:

1. A method of evaluating investment fund manager performance comprising:
collecting career information for a plurality of investment fund managers;
collecting fund information for a plurality of investment funds across a fund universe;
associating the career information of an investment fund manager to the fund information for related investment funds to generate career performance information for each of the plurality of investment fund managers;
determining a group of investment fund managers based on at least one criterion;
comparing the career performance information of at least one member of the group to a benchmark to generate at least one career performance record; and
analyzing the at least one career performance record.

2. The method of claim 1 wherein the career information is inception date on an investment fund, end date on an investment fund, name of an investment fund, biographical data, or any combination thereof.

3. The method of claim 1 wherein the fund information comprises performance data and fund data.

4. The method of claim 3 wherein the performance data is net asset value, yield, total return, or any combination thereof.

5. The method of claim 3 wherein the fund data is a fund name, an investment objective, a risk factor, a fund type, or any combination thereof.

6. The method of claim 1 wherein the fund universe is retail closed-end mutual funds, retail open-end mutual funds, international funds, separate accounts, hedge funds, private equity, venture capital, alternative asset classes, or any combination thereof.

7. The method of claim 1 wherein the at least one criterion is a specified time period, a market condition, a risk related condition, an investment objective, a risk factor, a fund type, or any combination thereof.

8. The method of claim 1 wherein the benchmark is the group of investment fund managers, another member of the group of investment fund managers, a fund family, a correlated index, correlated indices, or any combination thereof.

9. The method of claim 1 further comprising
determining a second group of investment fund managers based on the at least one criterion, wherein the benchmark is the second group of investment fund managers or a member of the second group of investment fund managers.

10. The method of claim 1 wherein the analyzing step analyzes relative return career, five year relative return, three year relative return, two year relative return, one year relative return, risk-adjusted relative return career, risk-adjusted index return, index volatility, manager volatility, front-weighted average return, seasonality, cyclicality, or any combination thereof.

11. The method of claim 1 wherein the analyzing step is tracking, monitoring, reviewing, ranking, or any combination thereof.

12. The method of claim 1 further comprising
generating at least one list based on the at least one career performance record.

13. The method of claim 12 further comprising
creating at least one index based on the at least one generated list.

14. The method of claim 13 further comprising
creating at least one investment vehicle based on the at least one index.

15. A system for evaluating investment fund manager performance comprising:
a user interface for receiving career information for a plurality of investment fund managers and receiving fund information for a plurality of investment funds;
a memory for storing the career information and the fund information; and
a processor coupled to the user interface and the memory, the processor performing the steps of
associating the career information of an investment fund manager to the fund information for related investment funds to generate career performance information for each of the plurality of investment fund managers;
determining a group of investment fund managers based on at least one criterion;
comparing the career performance information of at least one member of the group to a benchmark to generate at least one career performance record; and
analyzing the at least one career performance record.

16. The system of claim 15 wherein the at least one criterion is a specified time period, a market condition, a risk related condition, an investment objective, a risk factor, a fund type, or any combination thereof.

17. The system of claim 15 wherein the benchmark is the group of investment fund managers, another member of the group of investment fund managers, a fund family, a related index, related indices, or any combination thereof.

18. The system of claim 15 wherein the analyzing step is tracking, monitoring, reviewing, ranking, or any combination thereof.

19. The system of claim 15 wherein the processor further performs the step of
generating at least one list based on the at least one career performance record.

20. The system of claim 19 wherein the processor further performs the step of
creating at least one index based on the at least one generated list.

21. The system of claim 20 wherein the processor further performs the step of
creating at least one investment vehicle based on the at least one index.

22. The system of claim 15 wherein the analyzing step analyzes relative return career, five year relative return, three year relative return, two year relative return, one year relative return, risk-adjusted relative return career, risk-adjusted index return, index volatility, manager volatility, front-weighted average return, seasonality, cyclicality, or any combination thereof.
